(19) United States
(12) Patent Application Publication
(10) Pub. No.: US 2021/0349896 A1
(43) Pub. Date: Nov. 11, 2021

(54) SERUM OF TRUTH

(71) Applicant: Billy David TEA, Woburn, MA (US)

(72) Inventor: Billy David TEA, Woburn, MA (US)

(21) Appl. No.: 16/868,023

(22) Filed: May 6, 2020

(51) Int. Cl. G06F 16/2458; G06F 21/45

(52) U.S. Cl. CPC G06F 16/2465; G06F 21/45

(57) ABSTRACT

A computer implemented method for topic-based data mining, cataloging and aggregation through a computer readable program. The method is initiated with a determination of an industry type of a user and collection of the data pertaining of the determined industry. An encryption type of the collected data is determined and a timeframe of the data collection is associated with the user's input. The method then cleanse a duplicate data, white spaces and errors in the collected data and the data verification for an individual, a company and an information is performed. The verified data is then mapped with a plurality of resources to determine a propagation of data over time and a report is generated on the basis of the trustworthiness of the data.

### FIELD OF INVENTION

The present invention generally relates to a data aggregation method and particularly relates to a method for mining and cataloguing a data based on a research topic, verifying an authenticity of the data and aggregating the relevant data.

### BACKGROUND OF THE INVENTION

As the amount of electronic information continues to increase, the demand for sophisticated information access systems also grows. Over the years, new types of information access systems such as data mining systems have become commercially available.

Data mining systems commonly utilize statistical procedures to detect patterns in data; users are expected to interpret the patterns to find the answers. The current interests and successful commercial uses of data mining systems are due to the premise that these systems are designed to use the same set of data which is already used by the legacy database management systems.

For a number of years, both manual and automatic approaches to constructing knowledge bases have been studied and implemented; however, manual construction of knowledge bases has been too expensive to be practical, and automatic approaches have not yet produced domain-independent and usable knowledge bases. The CYC project was an attempt to build a common-sense knowledge base, containing all the information necessary for a person to understand a one volume desk encyclopedia and a newspaper. The project began in 1984, with specially trained knowledge editors manually entering knowledge in the CYC database. The knowledge base is still incomplete. In recent years, there has been increased interest in textual information extraction research using natural language processing techniques. The most common medium of storing knowledge is texts. Textual information extraction extracts and organizes knowledge from texts automatically.

However, in the prior art manual and automatic method for searching a plurality of reference documents relevant to a research topic proves inefficient as the data mining is not done on a basis of scope of the topic. Also, the mined data in the prior arts is not verified which leads to faulty assumptions and research paper creation.

In the view of foregoing, there is a need for a method for topical data cataloguing, verifying and aggregation for a research purpose.

### SUMMARY OF THE INVENTION

The primary object of the present invention is to provide a method for topical data cataloguing, verifying and aggregation for a research purpose.

Another objective of the present invention is to provide a method for recording a chronological progression of data through published media to verify the final publication.

Yet another object of the present invention is to provide a method for mapping a high volume of references by creating relative points of similarities.

The various embodiments of the present invention provide a computer implemented method for topic-based data mining, cataloging and aggregation through a computer readable program. The method comprises the steps of:
tracing a source of a reference information appearing as a result of a topical search on a search platform;
checking a background of the reference information in a chronological manner;
mapping a propagation of the reference information over the online media platforms;
calculating a degree of relativity among the online media platforms to identify a closeness of interpretation; and
identifying key parameters acted to catalyze the propagation of the information. The relativity of the information and the key parameter assist in the data aggregation.

According to one embodiment of the present invention, the key parameters comprises an influencer, an event and an indicator.

According to one embodiment of the present invention, the computer readable program provides a degree of relativity of high volume of references & citations identified on the online media platforms.

According to one embodiment of the present invention, the computer readable program creates a pedigree tree layering design based on a propagation of the information over the online media platform.

According to one embodiment of the present invention, the tree layering design comprises a chronological order of the appearance of the key parameter during the propagation of the reference information.

According to one embodiment of the present invention, the propagation data is analyzed by the computer readable program for authenticating a content of the reference information.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

Other objects, features, and advantages of the invention will be apparent from the following description when read with reference to the accompanying drawings. In the drawings, wherein like reference numerals denote corresponding parts throughout the several views:

FIG. 1 illustrates a flowchart of a method for topical data cataloguing, verifying and aggregation for a research purpose, according to one embodiment of the present invention.

FIG. 2 illustrates a flowchart of a process for verification of the collected data, according to one embodiment of the present invention;

FIG. 3 illustrates a flow diagram of mapping of the verified data with a plurality of vectors to identify a progression of data over time, according to one embodiment of the present invention.

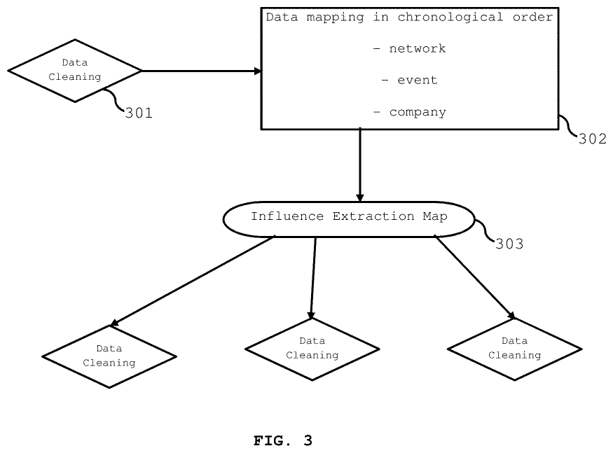

FIG. 4 illustrates an exemplary data time map, according to one embodiment of the present invention.

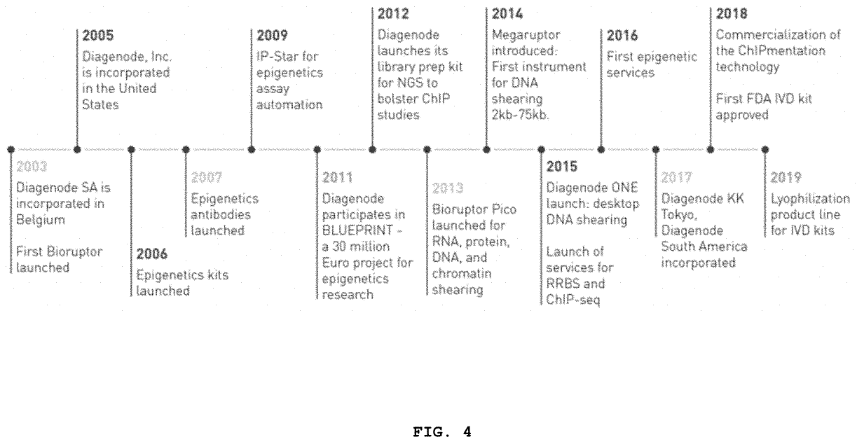

FIG. 5 illustrates an exemplary network map, according to one embodiment of the present invention.

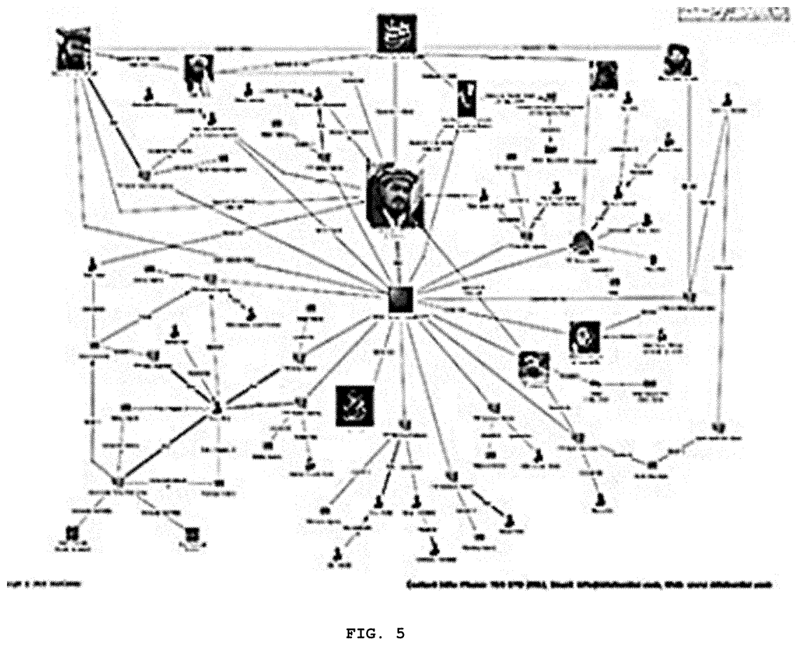

### DETAILED DESCRIPTION OF THE PREFERRED EMBODIMENTS

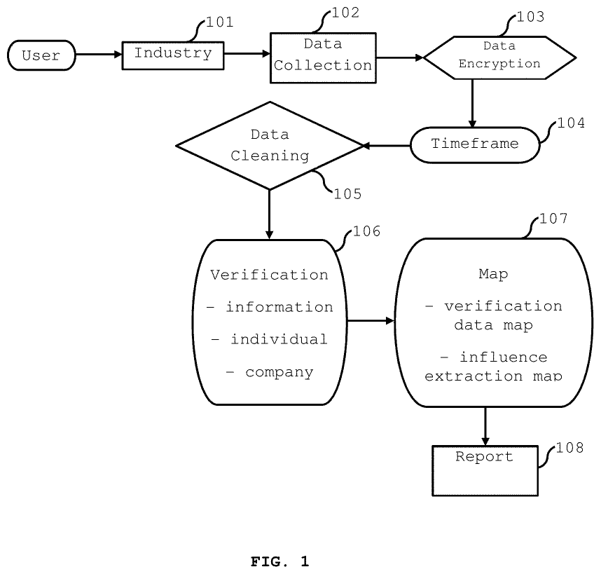

FIG. 1 illustrates a flowchart of a method for topical data cataloguing, verifying and aggregation for a research purpose, according to one embodiment of the present invention. With respect to FIG. 1, the method is primarily implemented to researching a topic or a subject but not limited to the same. The method is initiated with a determination of an industry type of a user (101) and collection of the data pertaining of the determined industry (102). An encryption type of the collected data may be determined (103) and a timeframe of the data collection is associated with the user's input (104). The method then cleanse a duplicate data, white spaces and errors in the collected data (105) and the data verification for an individual, a company and an information is performed (106). The verified data is then mapped with a plurality of resources to determine a propagation of data over time (107) and a report is generated on the basis of the trustworthiness of the data (108).

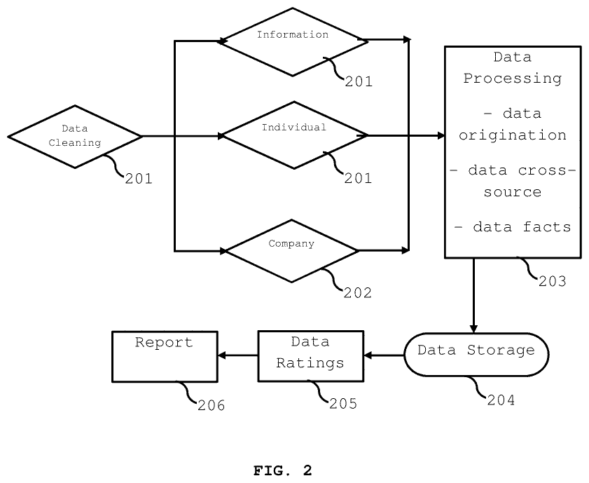

As shown in FIG. 2, the data verification process comprises a scope definition for an information, an individual and a company (201 & 202). The data is processed to record a data origination point, a plurality of cross-sources for the data and a factual reliability of the data (203). The processed information pertaining to the data is stored in a central database (204) and rated on the basis of trustworthiness (205). A report for the stored data is generated describing findings on the various recorded parameters such as data origination, data cross source and data fact (206).

Further, the mapping of data is done by mapping the data in chronological order through a plurality of networks, events and companies (301 & 302). The parameters which are influencing or have influence the data propagation are listed and a report is generated for the same (303).

According to one embodiment of the present invention, the information is considered to be a data that is accurate, timely, specific and organized for a purpose, presented within a context that gives it meaning and relevance, and can lead to an increase in understanding and decrease in uncertainty. The data origination comprises to identify how information, individual and company spread over a period of time through various data cross sources including primary, secondary, tertiary sources. A data trustworthiness is over a scale devised as 0-20 (Strongly Untrustworthy); 20-40 (untrustworthy); 40-60 (Neutral & Don't know); 60-80 (Some Trustworthiness); 80-100 (Strongly trustworthy). The method combines primary, secondary, and tertiary information to be rated.

In one embodiment, the general definition of primary, secondary and tertiary sources can be as follows:

Primary Source: first hand evidence gathered by the author(s) including peer reviewed;

Secondary Source: information that is described, interpreted or analysed from other resources—for instance primary resources

Tertiary Source: Information that is compiled and summarized mostly by secondary sources.

According to one embodiment of the present invention, the report comprises:
information: ratings out of 100
Facts supporting the statement
Sources of the information
Context of the information
Individuals: ratings out of 100
Family background—Social-economic status of growing up;
Education—Primary, secondary, college, university;
Professional—Internships & companies;
External Review—Personal and professional connections rate the knowledge and trustworthiness of the Individual;
Hobbies—Interest Groups, music, travels;
Political affiliation—What kind of political ideologies that he fits into;
Red flags—Any past Information that shows the individual has past experiences in doing, advocating, promoting illegal or non-trustworthy actions;
Company: ratings out of 100
Key individuals of the company—chairman, CEOs, Board of Directors etc.;
History of the company—How did the company grew from the beginning—Combination of T2 origination/Mapping;
Revenue & funding model—How do they make money; How is the company being finance;
Partnership & collaboration—Individuals and companies that supports the company;
External Review—Personal and professional connections rate the professionalism and trustworthiness of the company;
Political affiliation—What is the company line on political issues;
Red flags—has the company promoted any illegal or non-trustworthy activities?

According to one embodiment of the present invention, the data verification establishes a roadmap of how the individual, company, government has grown over time. The data influence extraction map is done to identify the key individuals, events, companies. The data verification allows for competitive advantage by having an in-depth understanding of history of an individual and company for better decision-making.

According to one embodiment of the present invention, the key parameters comprises an influencer, an event and an indicator.

According to one embodiment of the present invention, the computer readable program provides a degree of relativity of high volume of references & citations identified on the online media platforms.

According to one embodiment of the present invention, the computer readable program creates a pedigree tree layering design based on a propagation of the information over the online media platform.

According to one embodiment of the present invention, the tree layering design comprises a chronological order of the appearance of the key parameter during the propagation of the reference information.

According to one embodiment of the present invention, the propagation data is analyzed by the computer readable program for authenticating a content of the reference information.

The computer readable program provides two benefits over the conventional methods of data mining and aggregation:

### Verification of Accuracy of the Information

In order to assure that the information was reliable it was paramount to trace the information back the source. This in turn leads to a time-consuming work of verifying citations and sources in secondary sources. Indeed, primary sources are much easier to check as there are quotations and videos recording of the individual's statements. In secondary quotes or citations can be taken out of context, which can change the meaning of the quotation and therefore of the information. It is important to trace back the original source of the information and to put in context in order to have a clear view of the statement of the individual. Once the source had been found, the computer readable program runs a quick background check on the individual in order to assure the quality of the information.

2) “Map Out” how the Information was Spread in the Media

Once the source of the information has been located it is essential to “map out” how the information was spread through individuals not limited to analyst, researchers and journalists—this provides a detail chronological series of key influencers/events/indicators that were able to spread the information (catalyst).

As will be readily apparent to those skilled in the art, the present invention may easily be produced in other specific forms without departing from its essential characteristics. The present embodiments are, therefore, to be considered as merely illustrative and not restrictive, the scope of the invention being indicated by the claims rather than the foregoing description, and all changes which come within therefore intended to be embraced therein.

I claim:

1. A computer implemented method for topic-based data mining, cataloging and aggregation through a computer readable program comprising:
determining an industry type of a user;
collecting of the data pertaining of the determined industry;
determining an encryption type of the collected data;
associating a timeframe of the data collection is associated with the user's input;
cleansing a duplicate data, white spaces and errors in the collected data;
verifying the data for an individual, a company and an information;
mapping the verified data with a plurality of resources to determine a propagation of data over time; and
generating a report on the basis of the trustworthiness of the data.

2. The method as claimed in claim 1, wherein the key parameters comprise an influencer, an event and an indicator.

3. The method as claimed in claim 1, wherein the computer readable program provides a degree of relativity of high volume of references & citations identified on the online media platforms.

4. The method as claimed in claim 3, wherein the computer readable program creates a pedigree tree layering design based on a propagation of the information over the online media platform.

5. The method as claimed in claim 3, wherein the tree layering design comprises a chronological order of the appearance of the key parameter during the propagation of the reference information.

6. The method as claimed in claim 1, wherein the propagation data is analyzed by the computer readable program for authenticating a content of the reference information.
